(19) United States
(12) Patent Application Publication
(10) Pub. No.: US 2025/0350658 A1
(43) Pub. Date: Nov. 13, 2025

(54) LOW LATENCY MECHANISM FOR CLOUD TO COMPUTING SYSTEM HYBRID CLOUD

(71) Applicant: Intel Corporation, Santa Clara, CA (US)

(72) Inventors: Juan Zhao, Shanghai (CN); Jinwei Xie; Wenqing Fu, Portland, OR (US); Yuhui Lv, Shanghai (CN); Krishna Paul, Bangalore (IN); Curtis Jutzi, Lake Oswego, OR (US); Arvind Kumar, Beaverton, OR (US); Anand Rangarajan, Portland, OR (US); Huifeng Le, Shanghai (CN)

(73) Assignee: Intel Corporation, Santa Clara, CA (US)

(21) Appl. No.: 18/860,201

(22) PCT Filed: Jun. 23, 2022
(86) PCT No.: PCT/CN2022/100670

§ 371 Date: Oct. 25, 2024

(51) Int. Cl. H04L 67/1001

(52) U.S. Cl. CPC H04L 67/1001

(57) ABSTRACT

The disclosure includes receiving one or more updates to a global resource pool of a hybrid cloud and updating a local resource pool with the one or more updates to the global resource pool; intercepting a service request from an application; redirecting deployment of the service request to a resource provider of the hybrid cloud with available computing resources to fulfill the service request based at least in part on the local resource pool and by using a webhook; receiving an Internet Protocol (IP) address of the resource provider; redirecting a domain name service (DNS) of the application to the IP address of the resource provider; and sending the service request to the resource provider.

Portion of the disclosure of this patent document contains material to which a claim for copyright is made. The copyright owner has no objection to the facsimile reproduction by anyone of the patent document or the patent disclosure, as it appears in the Patent and Trademark Office patent file or records but reserves all other copyrights whatsoever.

### FIELD OF THE DISCLOSURE

This disclosure relates generally to hybrid cloud computing systems, and more particularly, to a low latency mechanism for coupling a computing system to one or more resource providers in a hybrid cloud.

### BACKGROUND

In some cloud computing environments, a client computing system may be used as an extension of the cloud to enhance cloud-native services to provide the best experience by leveraging the power of the cloud and the experience of the client. This allows cloud native Docker/OCI containers (such as Docker containers or Open Container Initiative (OCI) containers) to be deployed on the client upon the discovery of the client's capabilities and orchestrating the container deployment. An orchestration framework facilitates the deployment of these containers and the routing of the traffic from the web front-end of the client to the local containers.

Some clients have powerful computing capabilities, but some clients have limited resources. Each client is typically becoming more powerful, but one client is still not suitable for all computing tasks (e.g., some have extra graphics processing units (GPUs), some have extra storage, etc.). Both kinds of clients may be aggregated into a hybrid cloud. A hybrid cloud is a computing environment that combines an on-premises datacenter (also called a private cloud) with a public cloud, allowing data and applications to be shared between them. Container-based cloud to computing system orchestration needs to be improved. There may be shareable client resources (e.g., home/lab computing resources) in the hybrid cloud, but a client user needs a seamless and low latency method to access the services provided by the shared resources across multiple clients.

### BRIEF DESCRIPTION OF THE DRAWINGS

FIG. 1 illustrates a hybrid cloud computing arrangement according to some embodiments.

FIG. 2 is a flow diagram of hybrid cloud service request processing according to some embodiments.

FIG. 3 is a block diagram of an example processor platform structured to execute and/or instantiate the machine-readable instructions and/or operations of FIG. 2 to implement the apparatus discussed with reference to FIG. 1.

FIG. 4 is a block diagram of an example implementation of the processor circuitry of FIG. 3.

FIG. 5 is a block diagram of another example implementation of the processor circuitry of FIG. 3.

FIG. 6 is a block diagram illustrating an example software distribution platform to distribute software such as the example machine readable instructions of FIG. 2 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein provides a method and system for redirecting service requests for a computing resource to a resource provider in the hybrid cloud according to a local resource pool. In an implementation, the low latency call-back mechanism used to improve performance and security of updating the local resource pool and redirecting the service request is a webhook. Using the webhook, the control plane is accelerated by updating the local resource pool when new computing resources are available and the data plane is accelerated because with the added computing resources, service requests may be handled in the local hybrid cloud without using extra cloud services (even in computing systems with low end capabilities), and data transitions from local hybrid cloud to remote cloud are saved.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

As used herein, a computing system can be, for example, a server, a disaggregated server, a personal computer, a workstation, a self-learning machine (e.g., a neural network), a mobile device (e.g., a cell phone, a smart phone, a tablet (such as an iPad™)), a personal digital assistant (PDA), an Internet appliance, a digital video disk (DVD) player, a compact disk (CD) player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

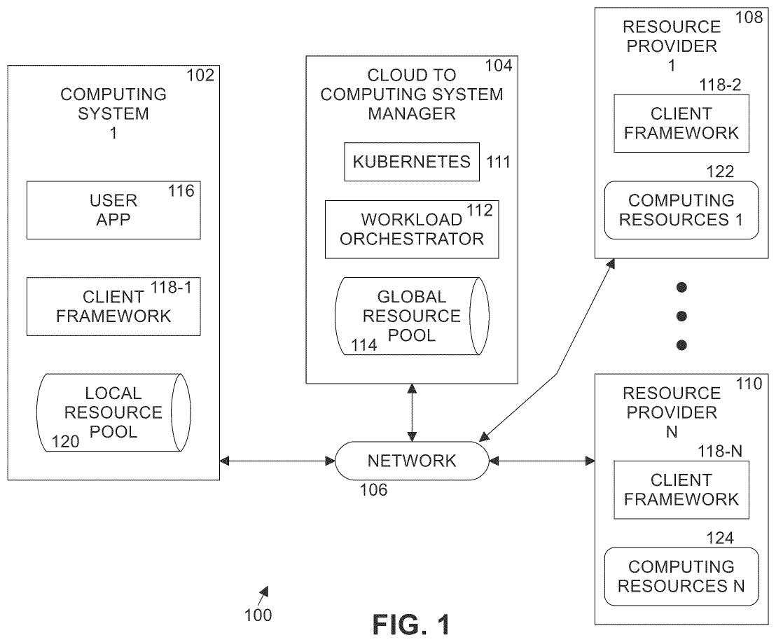

FIG. 1 illustrates a hybrid cloud 100 computing arrangement according to some embodiments. Computing system 1 102 includes one or more user application(s) 116, client framework 118-1, and local resource pool 120. Other traditional components of computing system 1 102 have been omitted from FIG. 1 for clarity. At a hardware level, computing system 1 102 includes one or more components. In an embodiment, each component comprises one or more of an System on a Chip (SoC), a central processing unit (CPU), a graphics processing unit (GPU), an XPU, a field programmable gate array (FPGA), a digital signal processor (DSP), an application specific integrated circuit (ASIC), an interconnect, a wireless modem, accelerator, integrated graphics circuitry, on-die memory, memory, storage, controller, other circuitry forming an intellectual property (IP) block, or other circuitry. User app 116, as part of any domain specific workload, may access computing resources available over network 106 from cloud to computing system manager 104. In a cloud computing environment, user app 116 accesses computing resources provided by a cloud service provider (CSP) via cloud to computing system manager 104 as needed to perform user app processing. Client framework 118-1 allows nodes inside a cluster to access each other and provides domain name server (DNS) services and Internet Protocol (IP) tables for routing data traffic. Local resource pool 120 aggregates resources available over a software defined network (SDN) comprising the hybrid cloud.

Cloud to computing system manager 104 is a management node inside the hybrid cloud 100 that sets up a communications network within the hybrid cloud. In one implementation, cloud to computing system manager 104 runs on a server in a data center. In one implementation, cloud to computing system manager 104 includes Kubernetes 111, a portable, extensible, open-source platform for managing containerized workloads and services, that facilitates both declarative configuration and automation.

Workload orchestrator 112 of cloud to computing system manager 104 orchestrates workload containers automatically in local clients such as computing system 1 102. In some scenarios, a simplified containerized application may be provisioned inside computing system 1 102. This allows the client (e.g., computing system 1 102) to participate in the orchestration. This is called single node orchestration. However, a goal is to enable a hybrid cloud capability in the home and/or lab computing environment to leverage available resources from other clients. To embrace the hybrid cloud and client computing, a better cloud/client orchestration method is desired. Resource sharing and service request redirection are useful for performance of orchestration. Cloud to computing system manager 104 cannot use the typical CSP methods to perform orchestration (e.g., install kubelets in new nodes and register the nodes into a centralized Kubernetes application program interface (API) server) because all nodes are required to be fully controlled by Kubernetes, which is undesirable to many client computing systems.

An improved method is needed because typical client computing systems may volunteer to share a computing resource but don't want to be fully monitored by Kubernetes, therefore a kubelet cannot be installed on the client. The existing method of Kubernetes can only be used for a single cluster but supporting a virtual resource pool (similar to a hybrid cloud in the cloud domain) is desired. One client may join the resource pool voluntarily and support orchestration automatically. Then each node (e.g., client computing system) is treated as a single cluster with a simplified Kubernetes installation (e.g., k3s).

Cloud to computing system manager 104 includes global resource pool 114 to keep track of available computing resources 1 122 . . . computing resources N 124 throughout the hybrid cloud. For example, a plurality of resource providers, such as resource provider 1 108 . . . resource provider N 110, include a plurality of computing resources, such as computing resources 1 122 . . . computing resources N 124, where N is a natural number. In an implementation, resource provider 1 108 . . . resource provider N 110 are computing systems accessible by computing system 1 102 over network 106. In an implementation, network 106 is the Internet. In other implementations network 106 may be an intranet or other communications system. Computing resources comprise any computing capability and components to provide such a capability (e.g., a CPU, GPU, XPU, ASIC, FPGA, memory, storage, etc.). Each resource provider includes a copy of client framework, such as client framework 118-2 . . . client framework 118-N to allow computing system 1 102 to communicate with the resource providers. In an implementation, resource provider 1 108 . . . resource provider N 110 are situated in the same local computing environment as computing system 1 102, such as a home, business, or lab.

Cloud to computing system manager 104 updates global resource pool 114 as needed. For example, if certain computing resources are being used (and thus are unavailable), these computing resources may be taken out of the global resource pool. Similarly, when the computing resources become available once more, or new computing resources are added to the hybrid cloud, then global resource pool 114 is updated accordingly. Whenever the global resource pool 114 is updated, local copies of this information, such as local resource pool 120, are also updated by applying a pool synchronization process. In this way, clients such as computing system 1 102 are always kept up to date on what computing resources 1 122 . . . computing resources N 124 are currently available in the hybrid cloud.

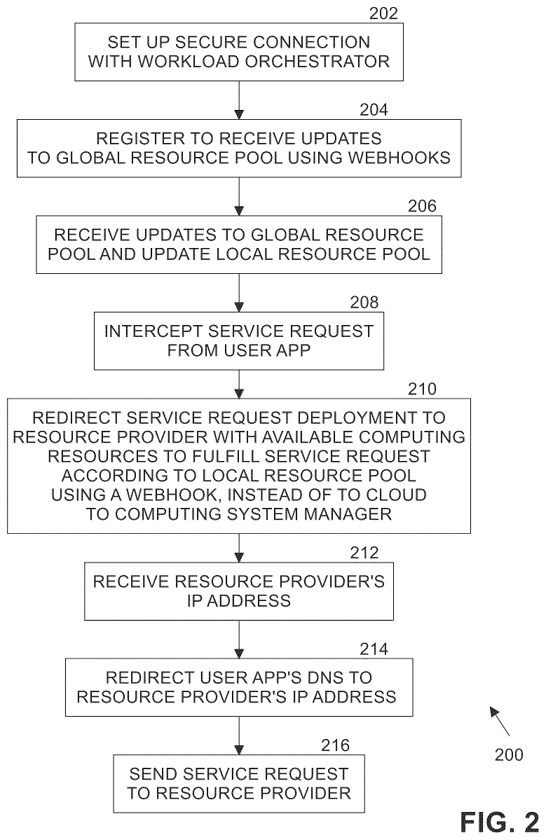

FIG. 2 is a flow diagram of hybrid cloud service request processing according to some embodiments. In an implementation, the resource pool for the hybrid cloud is maintained locally at computing system 1 102, a webhook mechanism is used to efficiently update the local resource pool 120 in computing system 1 102 when the global resource pool 114 is updated, and a webhook mechanism is used to receive a service request for a computing resource provided by a selected one of the resource providers and redirect the service request to the selected resource provider. At block 202, client framework 118-1 of computing system 1 102 sets up a secure connection with workload orchestrator 112 of cloud to computing system manager 104 when the hybrid cloud 100 is initiated. In an implementation, cloud to computing system manager 104 distributes a root certificate authority (CA) and generates client CAs for all members of the hybrid cloud, such as computing system 1 102 and resource providers 1 108 . . . N 110. This allows the hybrid cloud members to trust each other. Each client (computing system 1 102 and the resource providers) registers with cloud to computing system manager 104 and global resource pool 114 when the hybrid cloud is initiated or when computing resources of a client have changed.

At block 204, client framework 118-1 registers to receive updates to global resource pool 114 using webhooks. As used herein, a webhook is an event notification scheme using a hyper-text transport protocol (HTTP) callback comprising an HTTP post that occurs when an event happens.

Generally, webhooks are events that trigger an action. In some scenarios, they are used for automatic communications between systems. In some web programming, a webhook is a method of augmenting or altering the behavior of a web page or web application (e.g., user app 116) with custom call-backs. These callbacks may be maintained, modified, and managed by third-party users and developers who may not necessarily be affiliated with the originating website or application. In one example, the webhook is in a JavaScript object notation (JSON) format, and the request is done as a HTTP post request. Webhooks may be triggered by the update to the global resource pool 114. When that event occurs, cloud to computing system manager 104 makes an HTTP request to the uniform resource locator (URL) configured for the webhook (in this case, user app 116). Because webhooks use HTTP, they can be integrated into web services (such as those provided by user app 116) without adding new infrastructure.

In an implementation, blocks 202 and 204 are performed as part of initialization of the hybrid cloud. At block 206, when global resource pool 114 is updated due to one or more changes in computing resources on resource providers of the hybrid cloud, these updates are communicated using webhooks to client framework 118-1 in computing system 1 102 to update local resource pool 120. This keeps computing system 1 102 efficiently and continually up to date with any changes of computing resources in the hybrid cloud. Block 206 may be performed at any time an update is required.

In one implementation, resource providers send requests using a register application programming interface (API) provided by cloud to computing system manager system 104 to provide updates to resources available by the resource provider. The cloud to computing system manager uses a webhook to call a pool update callback API provided by the client framework 118-1 to report the pool update.

As user app 116 is running on computing system 1 102, user app 116 may make one more service requests to access information or perform computing tasks outside of computing system 1 102. At block 208, client framework 118-1 intercepts these service requests from user app 116. In one implementation, this is called a domain name server (DNS) intercept. At block 210, client framework 118-1 redirects deployment of the service request intercepted at block 208 to a selected resource provider with available computing resources to fulfill the service request according to local resource pool 120 (that is, based at least in part on the local resource pool) using a webhook, instead of allowing the service request to be handled by cloud to computing system manager 104. In one implementation, this redirection may be accomplished by using service deployment APIs provided by the resource providers.

As part of the redeployment, at block 212 client framework 118-1 receives the selected resource provider's IP address. At block 214, client framework 118-1 redirects the user app's DNS to the selected resource provider's IP address. At block 216, client framework 118-1 sends the service requested to the selected service provider. The selected service provider then performs the service request using the available computing resource provided by the selected service provider.

Although Kubernetes may be used in one implementation, in other implementations other tools may be written to redirect service requests and perform workload orchestration.

Table 1 shows an example pseudocode to be run in one implementation in client framework 118-1 of computing system 1 102 to provide a webhook path to receive events from the computing system lor the cloud to computing system manager 104.

```
TABLE 1
© 2022 Intel Corporation
go get -u github.com/go-playground/webhooks/v6
package main
import (
  “fmt”
  “net/http”
  “github.com/webhooks/cfc”
)
const (
  path = “/webhooks”
)
func main( ) {
  hook, _ :=
  cfc.New(github.Options.Secret(“MycfcSuperSecretSecrect...?”))
  http.HandleFunc(path, func(w http.ResponseWriter, r *http.Request) {
    payload, err := hook.Parse(r, cfc.PoolUpdate, cfc.DnsIntercept)
    if err != nil {
      if err == cfc.ErrEventNotFound {
          // ok event wasn't one of the ones asked to be parsed
      }
    }
    switch payload.(type) {
    case cfc.PoolUpdate:
      registerRP := payload.(cfc.PoolUpdate)
      // Update local pool
        .......
    case cfc.DnsIntercept:
      DNSI := payload.( cfc.dnsIntercept)
      // deploy service remotely
```

While an example manner of implementing the technology described herein is illustrated in FIGS. 1-2, one or more of the elements, processes, and/or devices illustrated in FIGS. 1-2 may be combined, divided, re-arranged, omitted, eliminated, and/or implemented in any other way. Further, the example processor circuitry may be implemented by hardware, software, firmware, and/or any combination of hardware, software, and/or firmware. Thus, for example, any of the example processor circuitry, the example memory circuitry, the example communication interface circuitry, could be implemented by processor circuitry, analog circuit(s), digital circuit(s), logic circuit(s), programmable processor(s), programmable microcontroller(s), GPU(s), DSP(s), ASIC(s), programmable logic device(s) (PLD(s)), and/or field programmable logic device(s) (FPLD(s)) such as FPGAs. When reading any of the apparatus or system claims of this patent to cover a purely software and/or firmware implementation, at least one of the example processor circuitry, the example memory circuitry, and/or the example communication interface circuitry is/are hereby expressly defined to include a non-transitory computer readable storage device or storage disk such as a memory, a DVD, a CD, a Blu-ray disk, etc., including the software and/or firmware. Further still, the example circuitry of FIG. 1 may include one or more elements, processes, and/or devices in addition to, or instead of, those illustrated in FIG. 1, and/or may include more than one of any or all the illustrated elements, processes and devices.

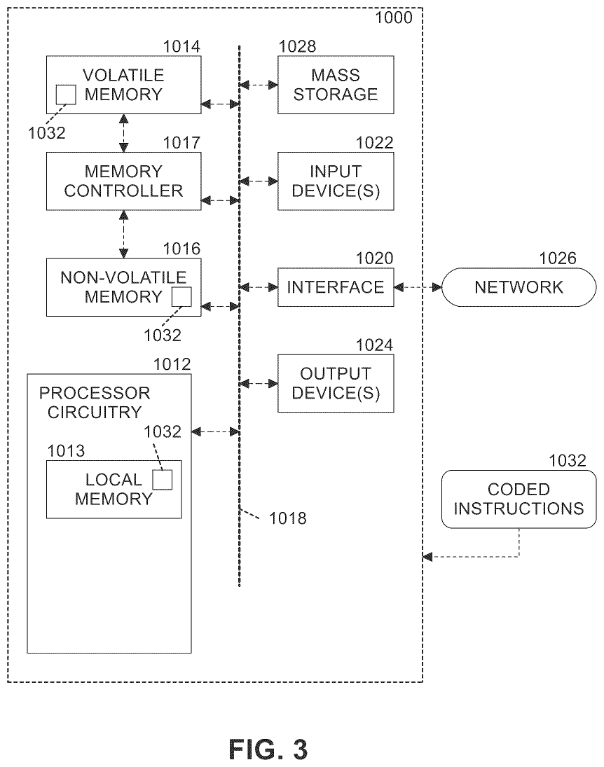

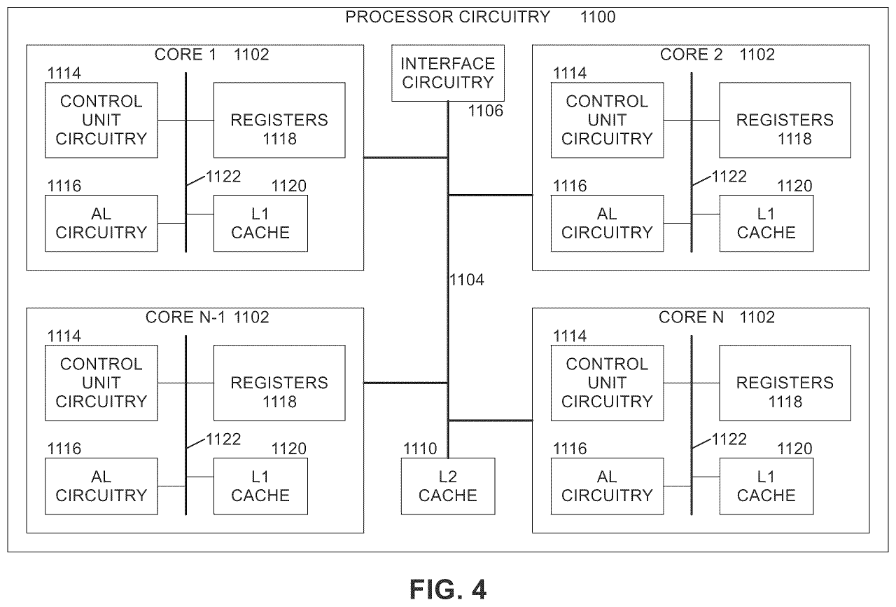

A flowchart representative of example hardware logic circuitry, machine readable instructions, hardware implemented state machines, and/or any combination thereof for implementing computing system 102 of FIG. 1 is shown in FIG. 2. The machine-readable instructions may be one or more executable programs or portion(s) of an executable program for execution by processor circuitry, such as the processor circuitry 712 shown in the example processor platform 700 discussed below in connection with FIG. 3 and/or the example processor circuitry discussed below in connection with FIGS. 4 and/or 5. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 2, many other methods of implementing the example computing system 102 may alternatively be used. For example, the order of execution of the blocks may be changed, and/or some of the blocks described may be changed, eliminated, or combined.

Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core CPU), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 2 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B. As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a block diagram of an example processor platform 1000 structured to execute and/or instantiate the machine-readable instructions and/or operations of FIG. 2 to implement the computing system 102 of FIG. 1. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements processing capabilities of computing system 102.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine-readable instructions of FIG. 2, may be stored in the mass storage device 1028, in the volatile memory 1014, in the non-volatile memory 1016, and/or on a removable non-transitory computer readable storage medium such as a CD or DVD.

FIG. 4 is a block diagram of an example implementation of the processor circuitry 1012 of FIG. 3. In this example, the processor circuitry 1012 of FIG. 4 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all the machine-readable instructions and/or operations represented by the flowchart of FIG. 2.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 3). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache (local memory 1120), and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 4. Alternatively, the registers 1118 may be organized in any other arrangement, format, or structure including distributed throughout the core 1102 to shorten access time. The bus may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

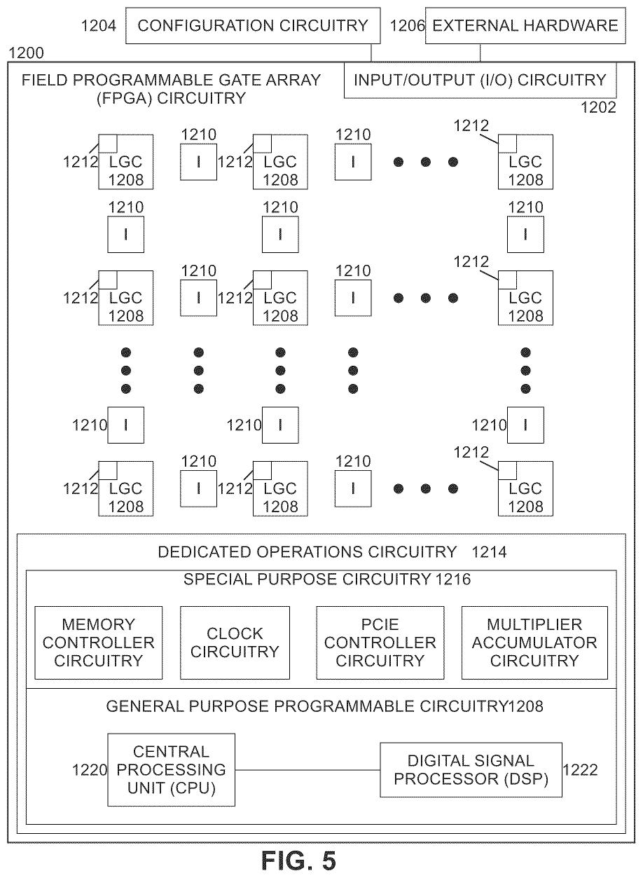

FIG. 5 is a block diagram of another example implementation of the processor circuitry 1012 of FIG. 3. In this example, the processor circuitry 1012 is implemented by FPGA circuitry 1200. The FPGA circuitry 1200 can be used, for example, to perform operations that could otherwise be performed by the example microprocessor 1100 of FIG. 4 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the microprocessor 1100 of FIG. 4 described above (which is a general purpose device that may be programmed to execute some or all of the machine readable instructions represented by the flowchart of FIG. 2 but whose interconnections and logic circuitry are fixed once fabricated), the FPGA circuitry 1200 of the example of FIG. 5 includes interconnections and logic circuitry that may be configured and/or interconnected in different ways after fabrication to instantiate, for example, some or all of the machine readable instructions represented by the flowchart of FIG. 2. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowchart of FIG. 2. As such, the FPGA circuitry 1200 may be structured to effectively instantiate some or all of the machine-readable instructions of the flowchart of FIG. 2 as dedicated logic circuits to perform the operations corresponding to those software instructions in a dedicated manner analogous to an ASIC. Therefore, the FPGA circuitry 1200 may perform the operations corresponding to the some or all of the machine-readable instructions of FIG. 2 faster than the general-purpose microprocessor can execute the same.

In the example of FIG. 5, the FPGA circuitry 1200 is structured to be programmed (and/or reprogrammed one or more times) by an end user by a hardware description language (HDL) such as Verilog. The FPGA circuitry 1200 of FIG. 5, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 4. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIG. 2 and/or other desired operations. The logic gate circuitry 1208 shown in FIG. 5 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 5 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 4 and 5 illustrate two example implementations of the processor circuitry 1012 of FIG. 3, many other approaches are contemplated. For example, as mentioned above, modern FPGA circuitry may include an on-board CPU, such as one or more of the example CPU 1220 of FIG. 5. Therefore, the processor circuitry 1012 of FIG. 3 may additionally be implemented by combining the example microprocessor 1100 of FIG. 4 and the example FPGA circuitry 1200 of FIG. 5. In some such hybrid examples, a first portion of the machine-readable instructions represented by the flowchart of FIG. 2 may be executed by one or more of the cores 1102 of FIG. 4 and a second portion of the machine-readable instructions represented by the flowchart of FIG. 2 may be executed by the FPGA circuitry 1200 of FIG. 5.

In some examples, the processor circuitry 1012 of FIG. 3 may be in one or more packages. For example, the microprocessor 1100 circuitry of FIG. 4 and/or the FPGA circuitry 1200 of FIG. 5 may be in one or more packages. In some examples, an XPU may be implemented by the processor circuitry 1012 of FIG. 3, which may be in one or more packages. For example, the XPU may include a CPU in one package, a DSP in another package, a GPU in yet another package, and an FPGA in still yet another package.

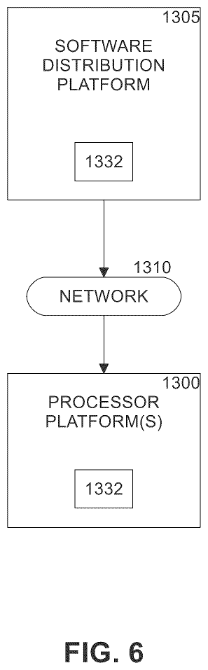

A block diagram illustrating an example software distribution platform 1305 to distribute software such as the example machine readable instructions 1032 of FIG. 3 to hardware devices owned and/or operated by third parties is illustrated in FIG. 6. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 3. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions described above, may be downloaded to the example processor platform 1300, which is to execute the machine-readable instructions 1032 to implement the methods described above and associated computing system 102. In some examples, one or more servers of the software distribution platform 1305 periodically offer, transmit, and/or force updates to the software (e.g., the example machine readable instructions 1032 of FIG. 3) to ensure improvements, patches, updates, etc., are distributed and applied to the software at the end user devices.

In some examples, an apparatus includes means for processing user app 116, client framework 118-1 and local resource pool 120 of FIG. 1. For example, the means for processing may be implemented by processor circuitry, firmware circuitry, etc. In some examples, the processor circuitry may be implemented by machine executable instructions executed by processor circuitry, which may be implemented by the example processor circuitry 1012 of FIG. 3, the example processor circuitry 1100 of FIG. 4, and/or the example Field Programmable Gate Array (FPGA) circuitry 1200 of FIG. 5. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed that provide defect scanning of components in a computing system. The disclosed systems, methods, apparatus, and articles of manufacture improve the efficiency of using a computing device by detecting when defects occur in components. The disclosed systems, methods, apparatus, and articles of manufacture are accordingly directed to one or more improvement(s) in the operation of a machine such as a computer or other electronic and/or mechanical device.

Example 1 is a method including receiving one or more updates to a global resource pool of a hybrid cloud and updating a local resource pool with the one or more updates to the global resource pool; intercepting a service request from an application; redirecting deployment of the service request to a resource provider of the hybrid cloud with available computing resources to fulfill the service request based at least in part on the local resource pool and by using a webhook; receiving an Internet Protocol (IP) address of the resource provider; redirecting a domain name service (DNS) of the application to the IP address of the resource provider; and sending the service request to the resource provider.

In Example 2, the subject matter of Example 1 can optionally include setting up a secure connection between a cloud manager and a client computing system when the hybrid cloud is initiated. In Example 3, the subject matter of Example 2 can optionally include registering to receive the one or more updates to the global resource pool from the cloud manager. In Example 4, the subject matter of Example 3 can optionally include receiving the one or more updates to the global resource pool using one or more webhooks. In Example 5, the subject matter of Example 1 can optionally include wherein the global resource pool and the local resource pool comprise a plurality of computing resources at a plurality of resource providers in the hybrid cloud available to fulfill service requests from the application. In Example 6, the subject matter of Example 1 can optionally include wherein the resource provider comprises a computing system of the hybrid cloud. In Example 7, the subject matter of Example 1 can optionally include wherein the hybrid cloud comprises a software defined network. In Example 8, the subject matter of Example 1 can optionally include wherein the hybrid cloud comprises a client computing system and a plurality of resource providers situated in a same local computing environment.

Example 9 is at least one least one non-transitory machine-readable storage medium comprising instructions that, when executed, cause at least one processor to receive one or more updates to a global resource pool of a hybrid cloud and updating a local resource pool with the one or more updates to the global resource pool; intercept a service request from an application; redirect deployment of the service request to a resource provider of the hybrid cloud with available computing resources to fulfill the service request based at least in part on the local resource pool and by using a webhook; receive an Internet Protocol (IP) address of the resource provider; redirect a domain name service (DNS) of the application to the IP address of the resource provider; and send the service request to the resource provider.

In Example 10, the subject matter of Example 9 can optionally include instructions that, when executed, cause at least one processor to set up a secure connection between a cloud manager and a client computing system when the hybrid cloud is initiated. In Example 11, the subject matter of Example 10 can optionally include instructions that, when executed, cause at least one processor to register to receive the one or more updates to the global resource pool from the cloud manager. In Example 12, the subject matter of Example 11 can optionally include instructions that, when executed, cause at least one processor to receive the one or more updates to the global resource pool using one or more webhooks. In Example 13, the subject matter of Example 9 can optionally include instructions that, when executed, cause at least one processor to wherein the global resource pool and the local resource pool comprise a plurality of computing resources at a plurality of resource providers in the hybrid cloud available to fulfill service requests from the application.

Example 14 is an apparatus including a memory to store instructions and a local resource pool; and a processor, coupled to the memory, to execute the instructions to receive one or more updates to a global resource pool of a hybrid cloud and updating the local resource pool with the one or more updates to the global resource pool; intercept a service request from an application; redirect deployment of the service request to a resource provider of the hybrid cloud with available computing resources to fulfill the service request based at least in part on the local resource pool and by using a webhook; receive an Internet Protocol (IP) address of the resource provider; redirect a domain name service (DNS) of the application to the IP address of the resource provider; and send the service request to the resource provider.

In example 15, the subject matter of Example 14 can optionally include the processor to set up a secure connection between a cloud manager and the apparatus when the hybrid cloud is initiated. In example 16, the subject matter of Example 15 can optionally include the processor to register to receive the one or more updates to the global resource pool from the cloud manager. In example 17, the subject matter of Example 16 can optionally include the processor to receive the one or more updates to the global resource pool using one or more webhooks. In example 18, the subject matter of Example 14 can optionally include wherein the global resource pool and the local resource pool comprise a plurality of computing resources at a plurality of resource providers in the hybrid cloud available to fulfill service requests from the application. In example 19, the subject matter of Example 14 can optionally include wherein the hybrid cloud comprises a software defined network. In example 20, the subject matter of Example 14 can optionally include wherein the hybrid cloud comprises the apparatus and a plurality of resource providers situated in a same local computing environment

Example 21 is an apparatus operative to perform the method of any one of Examples 1 to 8. Example 26 is an apparatus that includes means for performing the method of any one of Examples 1 to 8. Example 27 is an apparatus that includes any combination of modules and/or units and/or logic and/or circuitry and/or means operative to perform the method of any one of Examples 1 to 8. Example 28 is an optionally non-transitory and/or tangible machine-readable medium, which optionally stores or otherwise provides instructions that if and/or when executed by a computer system or other machine are operative to cause the machine to perform the method of any one of Examples 1 to 8.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

1-20. (canceled)

21. A method comprising:
receiving one or more updates to a global resource pool of a hybrid cloud and updating a local resource pool with the one or more updates to the global resource pool;
intercepting a service request from an application;
redirecting deployment of the service request to a resource provider of the hybrid cloud with available computing resources to fulfill the service request based at least in part on the local resource pool and by using a webhook; and
sending the service request to the resource provider.

22. The method of claim 21, further comprising:
receiving an Internet Protocol (IP) address of the resource provider;
redirecting a domain name service (DNS) of the application to the IP address of the resource provider; and
setting up a secure connection between a cloud manager and a client computing system when the hybrid cloud is initiated.

23. The method of claim 22, further comprising registering to receive the one or more updates to the global resource pool from the cloud manager.

24. The method of claim 23, further comprising receiving the one or more updates to the global resource pool using one or more webhooks.

25. The method of claim 21, wherein the global resource pool and the local resource pool comprise a plurality of computing resources at a plurality of resource providers in the hybrid cloud available to fulfill service requests from the application.

26. The method of claim 21, wherein the resource provider comprises a computing system of the hybrid cloud.

27. The method of claim 21, wherein the hybrid cloud comprises a software defined network.

28. The method of claim 21, wherein the hybrid cloud comprises a client computing system and a plurality of resource providers situated in a local computing environment.

29. At least one computer-readable medium having stored thereon instructions which, when executed, cause a computing device to perform operations comprising:
receiving one or more updates to a global resource pool of a hybrid cloud and updating a local resource pool with the one or more updates to the global resource pool;
intercepting a service request from an application;
redirecting deployment of the service request to a resource provider of the hybrid cloud with available computing resources to fulfill the service request based at least in part on the local resource pool and by using a webhook;
sending the service request to the resource provider.

30. The computer-readable medium of claim 29, wherein the operations further comprise:
receiving an Internet Protocol (IP) address of the resource provider;
redirecting a domain name service (DNS) of the application to the IP address of the resource provider; and
setting up a secure connection between a cloud manager and a client computing system when the hybrid cloud is initiated.

31. The computer-readable medium of claim 29, wherein the operations further comprise registering to receive the one or more updates to the global resource pool from the cloud manager.

32. The computer-readable medium of claim 29, wherein the operations further comprise receiving the one or more updates to the global resource pool using one or more webhooks.

33. The computer-readable medium of claim 29, wherein the global resource pool and the local resource pool comprise a plurality of computing resources at a plurality of resource providers in the hybrid cloud available to fulfill service requests from the application.

34. An apparatus comprising:
processor circuitry coupled to a memory to store instructions and a local resource pool, the processor circuitry to:
receive one or more updates to a global resource pool of a hybrid cloud and updating the local resource pool with the one or more updates to the global resource pool;
intercept a service request from an application;
redirect deployment of the service request to a resource provider of the hybrid cloud with available computing resources to fulfill the service request based at least in part on the local resource pool and by using a webhook;
send the service request to the resource provider.

35. The apparatus of claim 34, wherein the processor circuitry is further to:
receive an Internet Protocol (IP) address of the resource provider;
redirect a domain name service (DNS) of the application to the IP address of the resource provider; and
set up a secure connection between a cloud manager and the apparatus when the hybrid cloud is initiated.

36. The apparatus of claim 34, wherein the processor circuitry is further to register to receive the one or more updates to the global resource pool from the cloud manager.

37. The apparatus of claim 34, wherein the processor circuitry is further to receive the one or more updates to the global resource pool using one or more webhooks.

38. The apparatus of claim 34, wherein the global resource pool and the local resource pool comprise a plurality of computing resources at a plurality of resource providers in the hybrid cloud available to fulfill service requests from the application.

39. The apparatus of claim 34, wherein the hybrid cloud comprises a software defined network.

40. The apparatus of claim 34, wherein the hybrid cloud comprises the apparatus and a plurality of resource providers situated in a local computing environment, wherein the processor circuitry comprises application processor circuitry coupled to graphics processor circuitry.
